(19) United States
(12) Patent Application Publication
(10) Pub. No.: US 2024/0410994 A1
(43) Pub. Date: Dec. 12, 2024

(54) RANGING DEVICE AND RANGING METHOD

(71) Applicant: CANON KABUSHIKI KAISHA, Tokyo (JP)

(72) Inventor: AKIHIRO TAKAMURA, Tokyo (JP)

(21) Appl. No.: 18/672,610

(22) Filed: May 23, 2024

(30) Foreign Application Priority Data
Jun. 7, 2023 (JP) 2023-094206

(51) Int. Cl. G01S 7/4865; G01S 7/4863; G01S 7/487; G01S 17/10

(52) U.S. Cl. CPC G01S 7/4865; G01S 7/4863; G01S 7/4876; G01S 17/10

(57) ABSTRACT

A ranging device includes a light receiving unit including pixels for detecting pulsed light reflected by an object, a binning processing unit for converting signals output from unit regions each including at least one pixel into signals corresponding to pixel blocks each including at least two unit regions, a data accumulation unit for accumulating, for each pixel block, information indicating a relationship between a class determined according to a time period from emission to detection of the pulsed light and a frequency, based on the signals output from the binning processing unit, a reflected light determination unit for extracting, for each of the unit regions, a candidate of a class including a signal based on a reflected light from the object from the information, and a distance calculation unit configured to calculate a distance to the object corresponding to each of the unit regions based on the candidate.

### BACKGROUND

### Field of the Disclosure

The present invention relates to a ranging device and a ranging method.

### Description of the Related Art

As one of the ranging techniques, there is a technique of irradiating a predetermined range including a ranging target object with light from a surface light source, detecting reflected light from the ranging target object, and measuring a distance to the target object from a relationship between alight emission timing of the surface light source and a detection timing of the reflected light from the target object. This technology is called flash LiDAR (Light Detection And Ranging).

In the flash LiDAR, the surface light source emits light a plurality of times to integrate the reflected light, thereby improving the ranging accuracy. The integration of the reflected light is performed by generating histogram information representing the relationship between the distance and the frequency, but the memory capacity required for the processing increases in proportion to the increase in the number of pixels of the light receiving unit. Although it is possible to reduce the memory capacity necessary for processing by performing processing of collectively handling a plurality of pixels as one pixel, that is, so-called binning processing, it is not possible to avoid a decrease in resolution by simple binning processing.

Japanese Patent Application Laid-Open No. 2020-180941 (herein after called “PTL1”) discloses a technique of calculating a high-resolution distance by calculating a difference between a binned distance histogram and a distance histogram excluding an output of a part of regions. Japanese Patent Application Laid-Open No. 2010-071976 (herein after called “PTL2”) discloses a technique for estimating high-resolution distance information by extracting contour information of a high-resolution image and correcting the low-resolution distance information based on the extracted contour information. Japanese Patent Application Laid-Open No. 2020-118570 (herein after called “PTL3”) discloses a technique of performing pseudo high-resolution ranging by shifting a binning region at a narrower interval than the binning region.

However, the techniques described in PTL1, PTL2, and PTL3 cannot necessarily achieve both a reduction in memory capacity and a high resolution.

### SUMMARY

An object of the present disclosure is to provide a ranging device and a ranging method capable of reducing a memory capacity required while maintaining ranging accuracy and resolution.

According to one disclosure of the present specification, there is provided a ranging device including a light receiving unit including a plurality of pixels configured to detect a pulsed light emitted from a light emitting unit and reflected by an object in a measurement target region, a binning processing unit configured to convert a plurality of signals output from a plurality of unit regions each including at least one pixel into a plurality of signals corresponding to a plurality of pixel blocks each including at least two unit regions, a data accumulation unit configured to accumulate, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit, a reflected light determination unit configured to extract, for each of the plurality of unit regions, a candidate of a class including a signal based on a reflected light from the object from the information, and a distance calculation unit configured to calculate a distance to the object corresponding to each of the plurality of unit regions based on the candidate.

According to another disclosure of the present specification, there is provided a ranging device including a light receiving unit including a plurality of pixels configured to detect a pulsed light emitted from a light emitting unit and reflected by an object in a measurement target region, a binning processing unit configured to convert a plurality of first signals output from the plurality of pixels into a plurality of second signals having spatial resolution lower than that of the plurality of first signals, a data accumulation unit configured to accumulate, for each of a plurality of first unit regions corresponding to the plurality of second signals, information indicating a relationship between a class determined according to a time from when the pulsed light is emitted to when the pulsed light is detected by the light receiving unit and a frequency indicating the number of times the pulsed light is detected, based on the plurality of second signals output from the binning processing unit, a reflected light determination unit configured to extract, for each of a plurality of second unit regions corresponding to a plurality of signals having a spatial resolution higher than that of the plurality of second signals, a candidate of a class including a signal based on a reflected light from the object from the information, and a distance calculation unit configured to calculate a distance to the object corresponding to each of the plurality of second unit regions based on the candidate.

According to still another disclosure of the present specification, there is provided an information processing device including an input unit to which signals output from a plurality of pixels that detect pulsed light emitted from a light emitting unit and reflected by an object in a measurement target region are input, a binning processing unit configured to convert a plurality of signals output from a plurality of unit regions each including at least one pixel into a plurality of signals corresponding to a plurality of pixel blocks each including at least two unit regions, a data accumulation unit configured to accumulate, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit, a reflected light determination unit configured to extract, for each of the plurality of unit regions, a candidate of a class including a signal based on a reflected light from the object from the information, and a distance calculation unit configured to calculate a distance to the object corresponding to each of the plurality of unit regions based on the candidate.

According to still another disclosure of the present specification, there is provided a ranging method in which a pulsed light emitted from a light emitting unit and reflected by an object in a measurement target region is detected by a plurality of pixels and a distance to the object is calculated based on signals detected by the plurality of pixels, the method including converting a plurality of signals output from a plurality of unit regions each including at least one pixel into a plurality of signals corresponding to a plurality of pixel blocks each including at least two unit regions, accumulating, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit, extracting, for each of the plurality of unit regions, a candidate of a class including a signal based on a reflected light from the object from the information, and calculating a distance to the object corresponding to each of the plurality of unit regions based on the candidate.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment.

FIG. 2 is a timing diagram illustrating basic operation of LiDAR system.

FIG. 3A, FIG. 3B, FIG. 3C, and FIG. 3D are diagrams illustrating examples of histograms generated in the LiDAR system.

FIG. 4, FIG. 5, FIG. 6, and FIG. 7 are flowcharts illustrating the operation of the ranging device according to the first embodiment.

FIG. 8 is a diagram illustrating a configuration example of an entry held by a data accumulation unit of a distance calculation unit in the ranging device according to the first embodiment.

FIG. 9, FIG. 10, and FIG. 11 are flowcharts illustrating the operation of the ranging device according to the second embodiment.

FIG. 12 is a diagram illustrating a configuration example of an entry held by a data accumulation unit of a distance calculation unit in the ranging device according to the second embodiment.

FIG. 13 is a diagram illustrating a positional relationship between a focused pixel and peripheral pixels.

FIG. 14, FIG. 16, FIG. 17, and FIG. 18 are diagrams illustrating operation examples of the ranging device according to the second embodiment.

FIG. 15A and FIG. 15B are diagrams illustrating an example of the low-resolution histogram acquired in the first period and an example of the low-resolution histogram of the ambient light acquired in the second period.

FIG. 19 is a diagram illustrating a configuration example of a data area of a data accumulation unit in the ranging device according to a fourth embodiment.

FIG. 20A and FIG. 20B are diagrams illustrating a configuration example of a movable object according to a fifth embodiment.

### DESCRIPTION OF THE EMBODIMENTS

As described above, in a ranging device such as a flash LiDAR, a light source emits light a plurality of times to integrate reflected light, thereby improving the accuracy of distance measurement. The integration of the reflected light is performed by generating histogram information representing the relationship between the distance and the frequency, but the memory capacity required for the processing increases in proportion to the increase in the number of pixels of the light receiving unit. Although it is possible to reduce the memory capacity necessary for processing by performing processing of collectively handling a plurality of pixels as one pixel, that is, so-called binning processing, it is not possible to avoid a decrease in resolution by simple binning processing.

PTL1 discloses a technique of calculating a high-resolution distance by calculating a difference between a binned distance histogram and a distance histogram excluding an output of a part of regions. However, in the method described in PTL1, it is necessary to store a plurality of distance histograms excluding an output of a partial region. Therefore, in this method, a memory capacity equivalent to the memory capacity required for the distance histogram of the resolution before binning is required.

PTL2 discloses a technique for estimating high-resolution distance information by extracting contour information of a high-resolution image and correcting the low-resolution distance information based on the extracted contour information. However, in the method described in PTL2, when an object and a background are close colors, an outline cannot be obtained in an image, and an incorrect distance may be estimated.

PTL3 discloses a technique of performing pseudo high-resolution ranging by shifting a binning region at a narrower interval than the binning region. However, the method described in PTL3 merely shifts the phase of the pixel to be binned, and the essential distance resolution cannot be improved.

Preferred embodiments of the present invention will now be described in detail in accordance with the accompanying drawings.

### First Embodiment

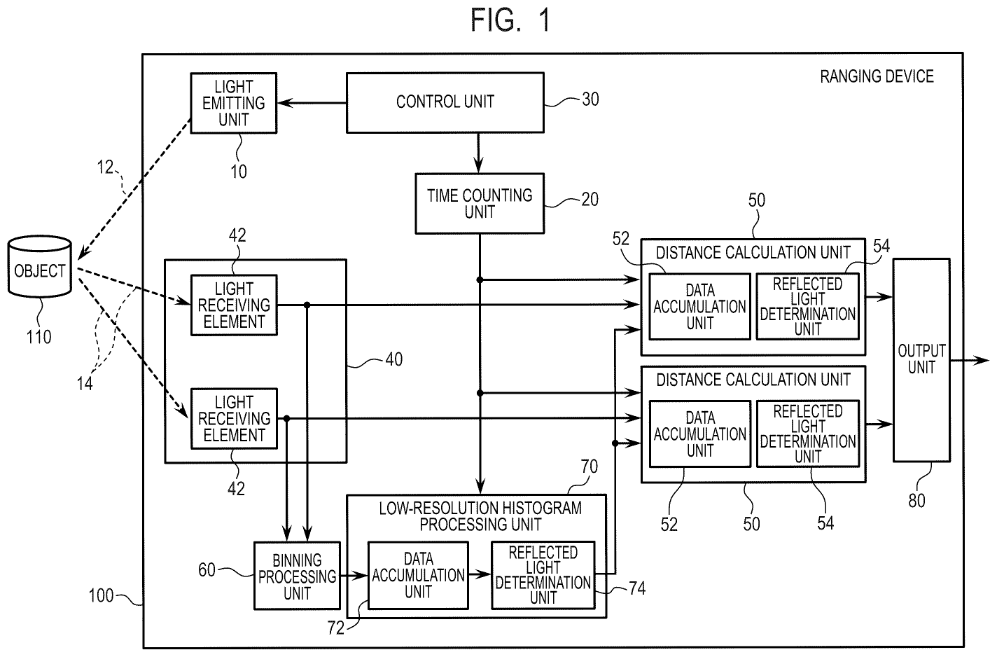

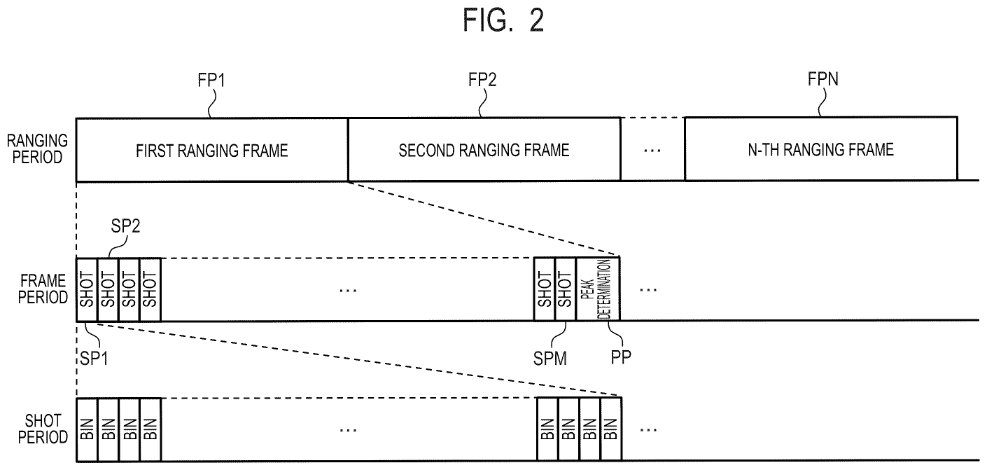

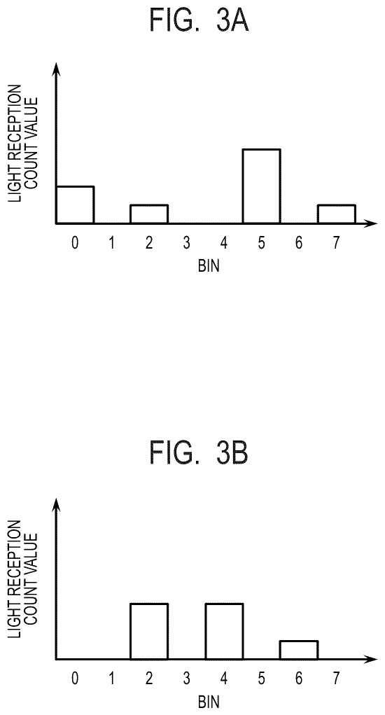

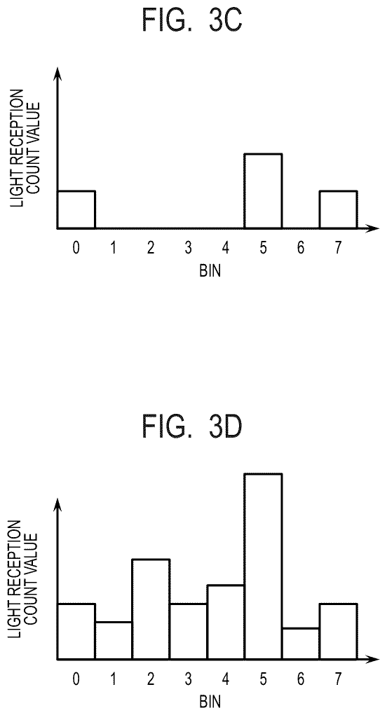

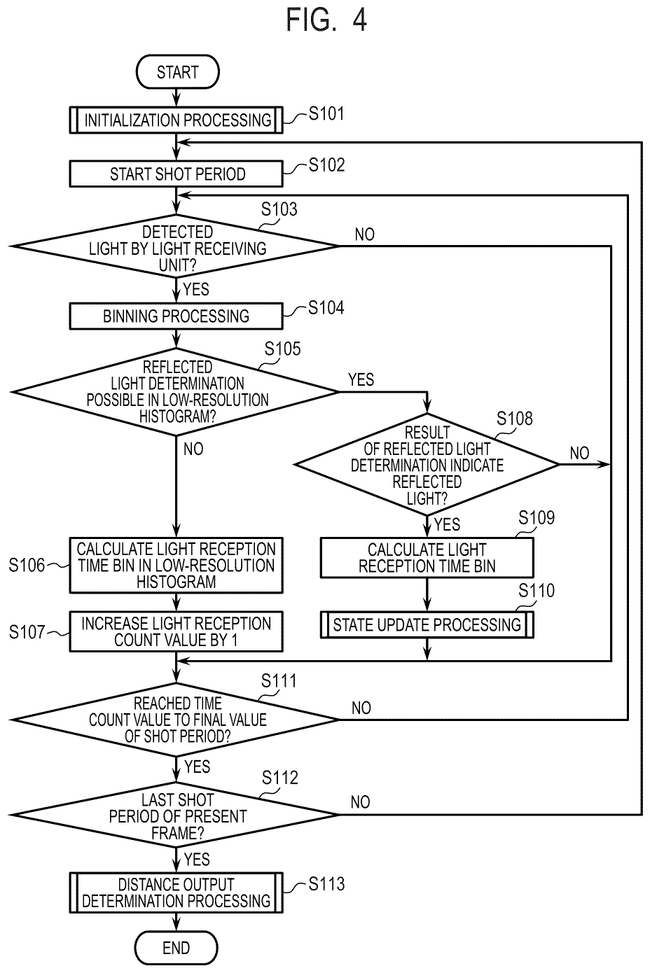

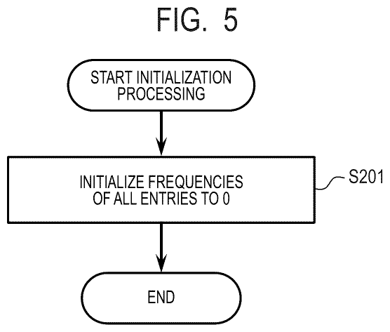

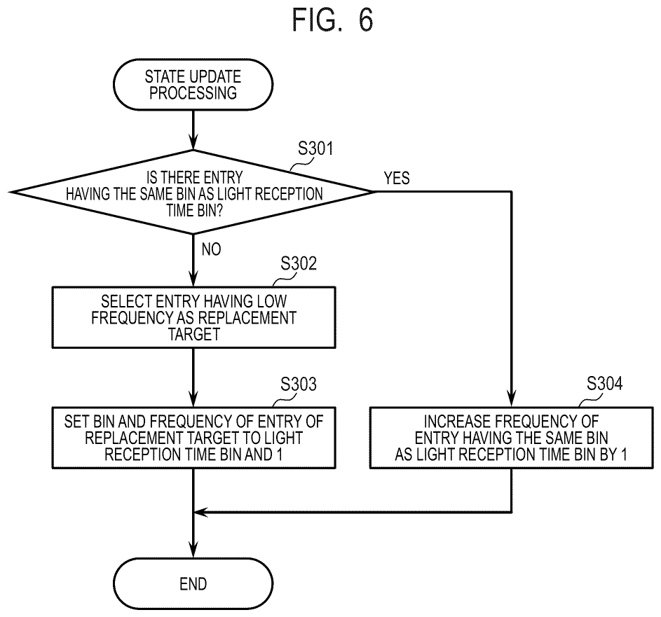

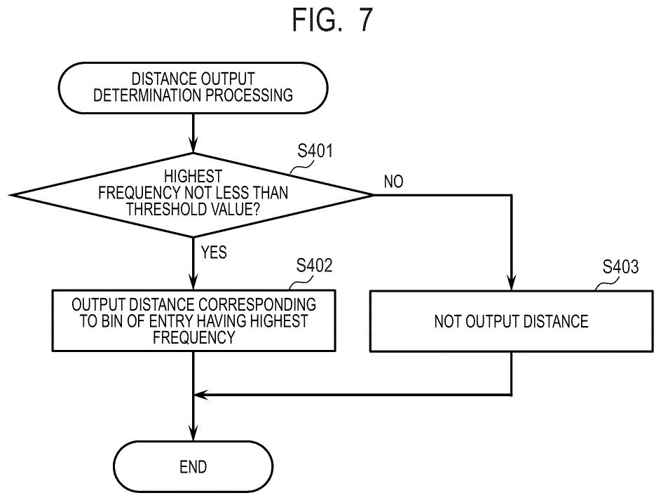

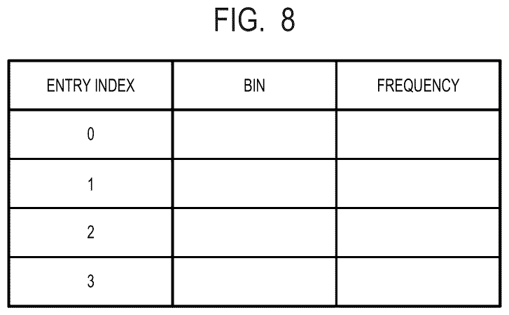

A ranging device and a ranging method according to a first embodiment will be described with reference to FIG. 1 to FIG. 8. FIG. 1 is a block diagram illustrating a schematic configuration of a ranging device according to the present embodiment. FIG. 2 is a timing diagram illustrating basic operation of LiDAR system. FIG. 3A to FIG. 3D illustrate examples of histogram information. FIG. 4 to FIG. 7 are flowcharts illustrating the operation of the ranging device according to the present embodiment. FIG. 8 is a diagram illustrating a configuration example of an entry held by a data accumulation unit of a distance calculation unit in the ranging device according to the present embodiment.

First, a schematic configuration of a ranging device according to the present embodiment will be described with reference to FIG. 1. As illustrated in FIG. 1, the ranging device 100 according to the present embodiment includes a light emitting unit 10, a time counting unit 20, a control unit 30, a light receiving unit 40, a distance calculation unit 50, a binning processing unit 60, a low-resolution histogram processing unit 70, and an output unit 80. The light receiving unit 40 includes a plurality of light receiving elements 42 two-dimensionally arranged. For simplification of the drawings, two of the plurality of light receiving elements 42 constituting the light receiving unit 40 are illustrated in FIG. 1. The distance calculation unit 50 includes a data accumulation unit 52 and a reflected light determination unit 54. The low-resolution histogram processing unit 70 includes a data accumulation unit 72 and a reflected light determination unit 74.

The control unit 30 is connected to the light emitting unit 10 and the time counting unit 20. Each of the light receiving elements 42 of the light receiving unit 40 is connected to the distance calculation unit 50 and the binning processing unit 60. In FIG. 1, in order to visually represent that the processing in the distance calculation unit 50 is performed on the signals output from each of the plurality of light receiving elements 42, the distance calculation unit 50 is illustrated as being divided into a plurality of blocks corresponding to the plurality of light receiving elements 42. The time counting unit 20 is connected to the distance calculation unit 50 and the low-resolution histogram processing unit 70. The binning processing unit 60 is connected to the data accumulation unit 72 of the low-resolution histogram processing unit 70. The data accumulation unit 72 is connected to the reflected light determination unit 74 of the low-resolution histogram processing unit 70. The reflected light determination unit 74 is connected to the distance calculation unit 50. The distance calculation unit 50 is connected to the output unit 80.

The light emitting unit 10 includes a light emitting element (not illustrated), and has a role of emitting pulsed light (irradiation light 12) such as laser light emitted from the light emitting element to a measurement target region. As the light emitting element constituting the light emitting unit 10, for example, an element capable of high-speed modulation such as an LED (Light Emitting Diode) or an LD (Laser Diode) may be applied. The light-emitting element may be VCSEL (Vertical Cavity Surface Emitting Laser) or a surface light-emitting element in which the light-emitting elements are arranged in an array. The light emitting unit 10 is preferably configured to emit light of a uniform amount to the measurement target region, and may further include an optical element, for example, a lens, for optically converting the light emitted from the light emitting element to irradiate the measurement target region.

The light receiving unit 40 has a function of detecting light incident from the measurement target region. The light incident on the light receiving unit 40 includes not only the environmental light in the measurement target region but also light (reflected light 14) of the irradiation light 12 reflected by the object 110 in the measurement target region. The light receiving element 42 converts the incident optical signal into an electrical signal and outputs the electrical signal to the distance calculation unit 50 and the binning processing unit 60. A pulse signal corresponding to the reflected light 14 is superimposed on the electrical signal output from the light receiving element 42 to the distance calculation unit 50. As the light receiving element 42, for example, a SPAD (Single Photon Avalanche Diode) sensor, a CMOS (Complementary Metal Oxide Semiconductor) sensor, or the like may be applied. The light receiving unit 40 may further include an optical element, such as a lens, for efficiently guiding the reflected light 14 to the light receiving element 42.

The number of light receiving elements 42 included in the light receiving unit 40 is not particularly limited, but in the present embodiment, for convenience of description, a light receiving unit 40 having 256 light receiving elements 42 in total, which are two-dimensionally arranged in (16 rows)×(16 columns), is assumed. In the present specification, the horizontal direction of the light receiving unit 40 is represented by an X axis, the vertical direction of the light receiving unit 40 is represented by a Y axis, and each light receiving element 42 is represented by an X-Y coordinate in some cases. The two light receiving elements 42 illustrated in FIG. 1 may be, for example, the light receiving element 42 disposed at the coordinates (0, 0) and the light receiving element 42 disposed at the coordinates (1, 0) among the 256 light receiving elements 42.

The control unit 30 generates a light emission control signal for controlling the light emission timing of the pulsed light in the light emitting unit 10, and transmits the generated light emission control signal to the light emitting unit 10. Further, the control unit 30 generates a count control signal synchronized with the light emission control signal, and transmits the generated count control signal to the time counting unit 20.

The time counting unit 20 starts time counting in response to the count control signal from the control unit 30, and counts up the time count value by 1 at regular time intervals. The time counting unit 20 sequentially transmits the time count value to the distance calculation unit 50 and the low-resolution histogram processing unit 70.

The binning processing unit 60 is a functional block that performs a process of combining signals from two or more pixels (here, the light receiving elements 42) as a signal from one larger pixel block, that is, a so-called pixel binning processing. Although the resolution is lowered by performing the pixel binning processing, the probability of receiving the reflected light 14 is increased, and thus it is possible to extend the distance that can be measured. Upon receiving the pulse signals from the respective light receiving elements 42 of the light receiving unit 40, the binning processing unit 60 performs pixel binning processing on these signals, and outputs a smaller number of signals than the signals received from the light receiving unit 40. In the present embodiment, for convenience of description, it is assumed that the pixel binning processing is performed for each of light receiving element blocks each including four light receiving elements in the horizontal direction and four light receiving elements in the vertical direction. For example, when the pixel binning processing is performed for each light receiving element block of (4 in the horizontal direction×4 in the vertical direction) on the signals from the light receiving unit 40 including 256 light receiving elements 42 in total (16 in the horizontal direction×16 in the vertical direction), signals from 16 pixel blocks in total (4 in the horizontal direction×4 in the vertical direction) are obtained. The number of pixels to be binned may be arbitrarily set.

The data accumulation unit 72 of the low-resolution histogram processing unit 70 generates histogram information for each pixel block after the binning processing based on the signals from the binning processing unit 60 and the time counting unit 20, and holds the generated histogram information. Here, the histogram information is information representing a relationship between a class of time (hereinafter, referred to as a “light reception time bin”) and the frequency of each bin. The light reception time bin is classified according to a time (a time count value from the time counting unit 20) from a timing at which the pulse light is emitted in the light emitting unit 10 to a timing at which the pulse signal is output from the light receiving element 42 according to the incidence of the reflected light 14. For example, when the time count value is counted up in units of 1 nanosecond and the light reception time bins are set at intervals of 10 nanoseconds, the number of the light reception time bin corresponding to the pulse signal from the light receiving element 42 may be calculated by performing an arithmetic operation of dividing the time count value by 10. The data accumulation unit 72 increments the light reception count value (frequency) of the light reception time bin corresponding to the received pulse signal by 1 every time the pulse signal is received for a predetermined period. By counting the number of times a pulse signal is detected in each bin for each pixel after binning processing in this way, histogram information for each pixel after binning processing may be generated.

The reflected light determination unit 74 of the low-resolution histogram processing unit 70 has a function of determining the presence or absence of the reflected light 14 for each pixel block after the binning processing based on the histogram information generated by the data accumulation unit 72, and outputting the determination result to the distance calculation unit 50. The reflected light determination unit 74 determines whether the determination of the reflected light 14 is possible when the pulse signal is received from the binning processing unit 60. For example, it is possible to set a state in which the determination of the reflected light 14 cannot be performed until a predetermined time in one frame, and set a state in which the determination of the reflected light 14 can be performed thereafter. If the reflected light 14 can be determined, the presence or absence of the reflected light 14 is determined for each pixel after the binning processing, and a signal corresponding to the determination result is output. For example, the reflected light determination unit 74 outputs a high-level signal (1) when the reflected light 14 is included, and outputs a low-level signal (0) when the reflected light 14 is not included. The determination as to whether or not the determination of the reflected light 14 is possible may be performed based on, for example, whether or not the light reception count value of the k-th bin from the top in the light reception count value is equal to or more than a constant value compared with the average of the light reception count values of the other bins, in addition to the above-described method.

Various criteria may be applied to the determination of the presence or absence of the reflected light 14 in the reflected light determination unit 74. For example, it is possible to determine that the reflected light 14 is present when there is one or more light reception count values exceeding a predetermined threshold value among the light reception count values of the respective bins, and to determine that the reflected light 14 is absent when there is no light reception count values exceeding the threshold value. In this case, the threshold value may be a constant value, or may be a value obtained by adding a constant value to the average value of the light reception count values of the respective bins. Further, since the S/N ratio is improved as the number of pixels to be binned increases, when the binning processing unit 60 is configured to be able to change the number of pixels to be binned, the threshold value may be changed according to the number of pixels to be binned.

The distance calculation unit 50 has a function of calculating the distance to the object 110 for each pixel (light receiving element 42) based on the signals from the light receiving unit 40, the time counting unit 20, and the reflected light determination unit 74. Upon receiving the pulse signal from the light receiving element 42, the distance calculation unit 50 acquires the time count value at that time from the time counting unit 20, and receives the determination result of the reflected light 14 corresponding to the pulse signal from the low-resolution histogram processing unit 70. Next, based on the output from the light receiving element 42 and the output from the low-resolution histogram processing unit 70, the distance calculation unit 50 determines whether or not there is a possibility that the light receiving element 42 has received the reflected light 14. The determination as to whether or not there is a possibility of receiving the reflected light 14 may be made using the output from the light receiving element 42 and the output from the low-resolution histogram processing unit 70, for example, as described in Table 1.

TABLE 1

| Light | Low-resolution | |
|---|---|---|
| receiving | histogram | |
| element | processing unit | Situation to be assumed as determination of |
| output | output | distance calculation unit |
| 0 | 0 | determine no reflected light is being received |
| 0 | 1 | determine no reflected light is being received |
| 1 | 0 | determine no reflected light is being received |
| 1 | 1 | determine there is possibility that reflected |
| | | light is being received |

However, when both the output from the light receiving unit 40 and the output from the low-resolution histogram processing unit 70 are 1, although there is a high possibility that the reflected light 14 is at that coordinate, there is also a possibility that it is environmental light. Therefore, the distance calculation unit 50 calculates a distance from the time count value corresponding to the pulse signal received from the light receiving element 42, and sets the distance as a candidate for a high-resolution distance in the coordinates of the light receiving element 42. Next, a distance candidate having a high possibility of being the reflected light 14 at the coordinates is selected from the calculated distance candidates, and is accumulated in the data accumulation unit 52. The reflected light determination unit 54 outputs the distance as the distance at the coordinate when it is determined that the high resolution distance at the coordinate is highly likely to be the correct distance, and outputs that there is no object whose distance can be measured at the coordinate otherwise.

Although an example in which the distance information is output at the resolution corresponding to the light receiving element 42 has been described above, the distance information may be output from the distance calculation unit 50 at a resolution different from the resolution corresponding to the light receiving element 42. In this case, a conversion unit (not illustrated) that converts the resolution (spatial resolution) of the light receiving unit 40 into the resolution of the distance calculation unit 50 may be inserted between the light receiving unit 40 and the distance calculation unit 50. This conversion unit may be configured to convert the resolution of the signal output from the light receiving unit 40 into a resolution higher than the resolution of the low-resolution histogram processing unit 70 and lower than the resolution of the signal output from the light receiving unit 40.

For example, the conversion unit may be configured to convert the plurality of signals output from the plurality of pixels into a plurality of signals corresponding to a plurality of unit regions each including at least one pixel. The binning processing unit 60 may be configured to convert a plurality of signals output from the plurality of unit regions into a plurality of signals corresponding to a plurality of pixel blocks each including at least two unit regions. In this case, each of the plurality of unit regions may include two or more first numbers of pixels, and each of the pixel blocks may include a second number of pixels greater than the first number.

In addition, it can be said that the binning processing unit 60 has a function of converting a plurality of first signals output from a plurality of pixels into a plurality of second signals whose spatial resolution is lower than that of the plurality of first signals. In this case, based on the plurality of second signals, the data accumulation unit 72 accumulates, for each of the plurality of first unit regions corresponding to the plurality of second signals, information indicating a relationship between a class determined according to a time until the pulsed light is detected and a frequency indicating the number of times the pulsed light is detected. The reflected light determination unit 74 extracts, from the information, a class candidate including a signal based on the reflected light from the object 110 for each of the plurality of second unit regions corresponding to the plurality of signals having a higher spatial resolution than the plurality of second signals. The distance calculation unit 50 calculates the distance to the object 110 corresponding to each of the plurality of second unit regions based on the candidate. Note that the plurality of signals having a higher spatial resolution than the plurality of second signals may be a plurality of first signals, and the plurality of second unit regions may be a plurality of pixels. Alternatively, the plurality of signals having a higher spatial resolution than the plurality of second signals may be a plurality of third signals having a higher spatial resolution than the plurality of second signals and different from the plurality of first signals.

The output unit 80 has a function of outputting the ranging information received from the distance calculation unit 50 to the outside.

FIG. 2 is a timing chart illustrating a basic operation of a general LiDAR system. During a ranging period of a general LiDAR system, a frame period FP of a predetermined length is sequentially performed a plurality of times. In FIG. 2, it is assumed that N-number of frame periods FP including a first frame period FP1, a second frame period FP2, . . . , and an N-th frame period FPN are performed during the ranging period. During each frame period FP, a plurality of shot periods SP and a peak determination period PP are executed. In FIG. 2, it is assumed that M-number of shot periods SP including a first shot period SP1, a second shot period SP2, . . . , and an M-th shot period SPM and a peak determination period PP are performed in one frame period FP. Each shot period SP is divided into a plurality of bins divided based on the time count.

One frame period FP corresponds to a period in which one distance image is acquired. In one shot period SP, the pulsed light is emitted from the light emitting unit 10 once. That is, each shot period SP starts from the timing at which the light emitting unit 10 emits the pulsed light, and the length of each shot period SP is defined by the interval at which the pulsed light is emitted. During each shot period SP, a counting operation of counting the pulse signal output from the light receiving unit 40 is performed for each bin divided based on the time count. In this way, by acquiring the light reception count value in each bin in each shot period SP, it is possible to acquire data (histogram information) including histogram information as illustrated in FIG. 3A to FIG. 3D.

FIG. 3A illustrates an example of the histogram acquired in the first shot period SP1, FIG. 3B illustrates an example of the histogram acquired in the second shot period SP2, and FIG. 3C illustrates an example of the histogram acquired in the third shot period SP3. FIG. 3D illustrates a histogram obtained by integrating the histograms of FIG. 3A to FIG. 3C.

As illustrated in FIG. 3A, in the histogram acquired in the first shot period SP1, the light reception count value in the bin 5 has a peak. As illustrated in FIG. 3B, in the histogram acquired in the second shot period SP2, the light reception count values in the bin 2 and the bin 4 have peaks. As illustrated in FIG. 3C, in the histogram acquired in the third shot period SP3, the light reception count value in the bin 5 has a peak. On the other hand, in the histogram obtained by integrating these values, as illustrated in FIG. 3D, the light reception count value in the bin 5 has a peak. In this way, by integrating the information of the plurality of shot periods SP, it is possible to determine a bin with a higher possibility of reflected light from the ranging target.

In the peak determination period PP, the distance to the target object 110 is calculated based on the time information of the bin in which the light reception count value is at the peak. The distance D [m] to the object 110 may be calculated by the following Equation (1). Here, t is a time count value (unit: second) acquired from the time counting unit 20 at the timing when the pulse signal is received from the light receiving unit 40, and c is the speed of light (2.998×10⁸ [m/see]).

$$D = c \times t / 2 [ m ] \qquad ( 1 )$$

For example, when the bins are set at intervals of 10 nanoseconds, the bin 5 in which the light reception count value indicates a peak corresponds to a class for counting pulse signals detected between 50 nanoseconds and 60 nanoseconds after light emission of the light emitting unit 10. Therefore, the distance D to the target object 110 may be calculated as 7.5 [m] to 9.0 [m] from Equation (1).

The processing in each shot period SP in the above-described general LiDAR system corresponds to the processing in the data accumulation unit 72 and the reflected light determination unit 74 of the low-resolution histogram processing unit 70 in the present embodiment. However, in the low-resolution histogram processing unit 70, the processing of the peak determination period PP is not performed. Instead, in a state in which the determination of the reflected light is possible, the reflected light determination unit 74 determines the presence or absence of reflected light for each coordinate and outputs the result. The state in which the determination of the reflected light is possible will be described later. The distance calculation unit 50 operates for each shot period SP in response to the output from the reflected light determination unit 74. After the last shot period SPM of the one frame period FP, it is determined whether or not the reflected light determination unit 54 can output the distance information instead of the reflected light determination unit 74. When determining that the distance information can be output, the reflected light determination unit 54 calculates the distance and outputs the distance information from the output unit 80.

Next, the operation of the ranging device according to the present embodiment will be described in more detail with reference to FIG. 4 to FIG. 8.

When the distance measurement is started, a plurality of frame periods FP is sequentially executed from the first frame period FP1, as described with reference to FIG. 2. When the frame period FP is started, first, in step S101, initialization processing of the data accumulation unit 52 of the distance calculation unit 50 is performed. As illustrated in FIG. 8, for example, an arbitrary number of entries corresponding to each pixel can be accumulated in the data accumulation unit 52. Each entry includes a data region for holding a bin and a frequency corresponding to the bin. Here, for example, as illustrated in FIG. 8, description will be made on the assumption that the number of entries of each pixel in the data accumulation unit 52 is four, but the number of entries may be arbitrarily set. The four entries are numbered 0, 1, 2, and 3 as entry indexes. In the initialization processing of step S101 in the present embodiment, as described in step S201 of FIG. 5, the frequency of each entry of each pixel is initialized to 0 in the data accumulation unit 52.

In the following step S102, the shot period SP is started. The shot period SP is started by emitting pulsed light from the light emitting unit 10 and starting time counting in the time counting unit 20 in synchronization with the emission of pulsed light under the control of the control unit 30. The counting of the time in the time counting unit 20 is started from 0. The counting of the time may be performed by, for example, a method of counting the clock signal. For example, in the case of using a clock signal having a period of 1 nanosecond, when the time count value increases from 0 to 10, 10 nanoseconds have elapsed.

Next, in step S103, it is determined whether or not the light receiving unit 40 has detected light. As a result of the determination, when at least one of the plurality of light receiving elements 42 constituting the light receiving unit 40 detects light (“YES” in step S103), the process proceeds to step S104. As a result of the determination, when the light receiving unit 40 does not detect light (“NO” in step S103), the process proceeds to step S111.

In step S104, the binning processing unit 60 performs binning processing on the signals detected by the plurality of light receiving elements 42 constituting the light receiving unit 40. Specifically, (floor(X/4), floor(Y/4)) is operated for the coordinates (X, Y) of each light receiving element 42, and the coordinates (Xi, Yi) are calculated for each light receiving element 42. Then, an output signal is generated for each coordinate (Xi, Yi) by performing superposition (logical sum operation) of output signals for each light receiving element 42 having the same coordinate (Xi, Yi). The floor(x) function is a function that returns a maximum integer equal to or less than x. By calculating (floor(X/4), floor(Y/4)) for the coordinates (X, Y), binning processing of 4×4 pixels may be performed. The binning processing unit 60 outputs the signal after the binning processing to the low-resolution histogram processing unit 70 as an output signal of each of the coordinates (XL, YL) of the low-resolution pixel.

In step S105, the reflected light determination unit 74 of the low-resolution histogram processing unit 70 determines whether or not each of the signals received from the binning processing unit 60 is in a state in which the reflected light 14 can be determined. As a result of the determination, when it is determined that the reflected light can be determined (“YES” in step S105), the process proceeds to step S108. As a result of the determination, when it is determined that the reflected light cannot be determined (“NO” in step S105), the process proceeds to step S106. Note that in this specification, a period during which the reflected light is not in a determinable state may be referred to as a first period, and a period during which the reflected light is in a determinable state may be referred to as a second period.

In step S106, the data accumulation unit 72 of the low-resolution histogram processing unit 70 calculates the light reception time bin in the low-resolution histogram based on the time count value acquired from the time counting unit 20. Note that the data accumulation unit 72 includes an accumulation region of a three-dimensional array, and can accumulate light reception count values for each combination of coordinates (XL, YL) of low resolution and bins.

In step S107, the data accumulation unit 72 increments the light reception count value of the light reception time bin in the low-resolution histogram calculated in step S106 by 1. After the process of step S107, the process proceeds to step S111.

In step S108, the reflected light determination unit 74 determines whether or not the low-resolution coordinate (XL, YL) signal is due to the reflected light. As a result, when it is determined that the signal is due to the reflected light (“YES” in step S108), the process proceeds to step S109. When it is determined that the signal is not due to the reflected light (“NO” in step S108), the process proceeds to step S111.

In step S109, the data accumulation unit 52 of the distance calculation unit 50 calculates the light reception time bin based on the time count value acquired from the time counting unit 20 corresponding to each of the signals from the pixels at the coordinates (X, Y).

In step S110, the data accumulation unit 52 performs a state update processing of updating a state of a distance that is likely to be reflected light with respect to the light reception time bin acquired in step S109. Details of the state update processing will be described later. After the state update processing, the process proceeds to step S111.

In step S111, it is determined whether or not the time count value has reached the final value corresponding to the end of the shot period SP. As a result of the determination, when the time count value has not reached the final value (“NO” in step S111), the process returns to step S103, and the shot period SP is continued. If it is determined that the time count value has reached the final value (“YES” in step S111), the process proceeds to step S112.

In step S112, it is determined whether or not the present shot period SP is the last shot period SPM in the present frame period FP. As a result of the determination, when the shot period SP is not the last shot period SPM in the present frame period FP (“NO” in step S112), the process returns to step S102, and the next shot period SP in the present frame period FP is started. As a result of the determination, when the shot period SP is the last shot period SPM of the present frame period FP (“YES” in step S112), the process proceeds to step S113.

In step S113, the reflected light determination unit 54 performs distance output determination processing for determining whether or not to output distance information. Specifically, it is determined whether or not the signals of the coordinates (Xi, Yi) after the binning processing include reflected light. As a result of the determination, when the reflected light is included, the distance calculation unit 50 calculates the distance from the bin in the distance calculation unit 50 and outputs the distance to the output unit 80. As a result of the determination, when the reflected light is not included, information indicating that there is no object whose distance can be measured is output to the output unit 80.

The state update processing of step S110 may be performed according to steps S301 to S304 of the flowchart illustrated in FIG. 6, for example. Step S110 may be executed corresponding to each signal of the coordinates (X, Y) in the data accumulation unit 52 of the distance calculation unit 50.

First, in step S301, it is determined whether or not the same bin as the light reception time bin calculated in step S109 is present in the bins of each entry of the data accumulation unit 52 illustrated in FIG. 8. As a result of the determination, when there is the same bin as the light reception time calculated in step S109 (“YES” in step S301), the process proceeds to step S304. If there is no bin that is the same as the light reception time bin calculated in step S109 (“NO” in step S301), the process proceeds to step S302.

In step S302, an entry having a low frequency among all entries is selected as a replacement target. An entry with the lowest frequency may be selected as the replacement target, or an entry with a lower frequency may be set to have a higher probability of replacement and may be selected using a random number. When there are a plurality of entries to be replaced under the same condition, the entries may be randomly selected, or an entry having a value close to the count value may be selected as an entry to be replaced using a circular counter in which the entry number is incremented by 1 every time replacement is performed so that the entries to be replaced are not biased.

In step S303, the bin of the entry of the replacement target selected in step S302 is set to the light reception time bin calculated in step S109, the frequency of the entry is set to 1, and the state update processing is ended.

In step S304, the frequency of the entry of the bin equal to the light reception time bin calculated in step S109 is increased by 1, and the state update processing is ended.

By repeatedly performing the state update processing in this manner, the value of the frequency increases as the number of times that it is determined that there is a possibility of including a signal due to reflected light from the object increases.

The distance output determination processing in step S113 may be performed in accordance with steps S401 to S403 of the flowchart illustrated in FIG. 7, for example. Step S113 is performed on each signal of the coordinates (Xi, Yi) in the reflected light determination unit 54 of the distance calculation unit 50.

First, in step S401, an entry having the highest frequency is extracted from the entries of the data accumulation unit 52 illustrated in FIG. 8, and it is determined whether or not the frequency is equal to or higher than a predetermined threshold value.

As a result of the determination, when the frequency is equal to or higher than the threshold value (“YES” in step S401), the process proceeds to step S402. When the frequency is less than the threshold value (“NO” in step S401), the process proceeds to step S403. The threshold value used for the determination may be set based on, for example, the maximum value or the average value of the frequencies at which the reflected light is not determined in the low-resolution histogram.

In step S402, it is determined that the entry having the highest frequency among the entries of the data accumulation unit 52 corresponds to the reflected light, and the bin of the entry is converted into a distance and output. As a result, the distance output determination processing is ended, and a series of processing of the frame is ended.

In step S403, it is determined that there is no entry corresponding to the reflected light in the entries of the data accumulation unit 52, and it is output that there is no object whose distance can be measured. As a result, the distance output determination processing is ended, and a series of processing of the frame is ended.

As described above, when it is determined that the reflected light is at the coordinates (XL, YL) of the low-resolution pixel by the state update processing illustrated in FIG. 6, the frequency of the bin with respect to the coordinates (X, Y) at which the light is received becomes large. When the frequency of the bin having the highest frequency is equal to or higher than a predetermined threshold value, it is determined that the bin indicates the reflected light, and the bin is converted into a distance and output.

By performing such processing, necessary memory capacity may be reduced. The reason for this will be described below by exemplifying a case in which the number of bins is 1000 (for example, the distance may be measured up to 100 m with a distance resolution of 10 cm) and the number of shot periods SP per frame period FP is 10,000 times. It is assumed that the number of pixels of the light receiving unit 40 (the number of the light receiving elements 42) is 256 pixels (16 pixels in horizontal direction ×16 pixels in vertical direction) as in the above example.

The memory capacity necessary for holding the histogram information is (the number of pixels)×(the number of bins)×(ceil(log₂(number of shots))) bits, and in the above example, is (16×16×1000×14=3,584,000) bits. Here, the ceil(x) function is a function that returns a minimum integer greater than or equal to x.

On the other hand, in the present embodiment, the memory capacity required to hold the low-resolution histogram information is ((the number of pixels)/(binning number in X direction)/(binning number in Y direction)×(the number of bins)×(ceil(log₂(number of shots))) bits. In the above example, (16×16/4/4×1000×14=224,000) bits. The memory capacity required for each pixel is ((4 entries)×(ceil(log₂(number of bins))+(ceil(log₂(number of shots)))) bits, and (16×16×4×(10+14)=24,576) bits for all pixels. The total is 248,576 bits, which can be significantly smaller than the number of 3,584,000 bits in the normal case.

As described above, according to the present embodiment, it is possible to reduce the required memory capacity while maintaining the ranging accuracy and resolution.

### Second Embodiment

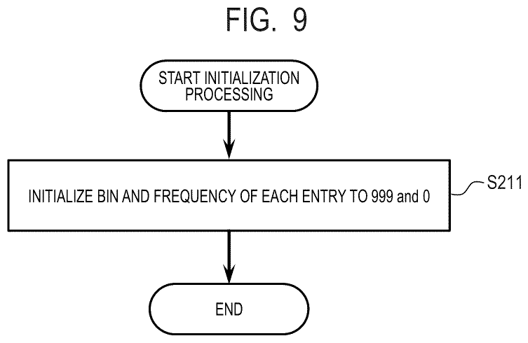

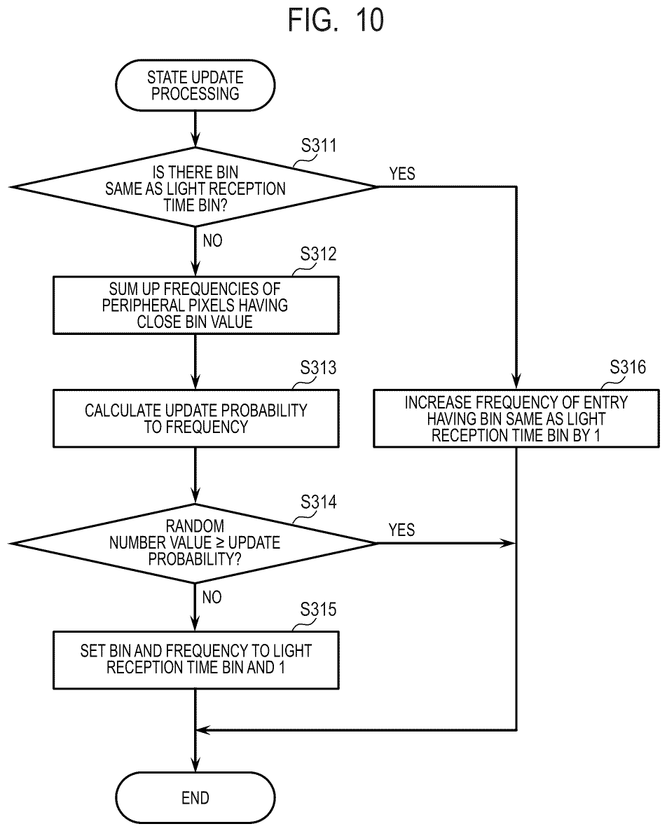

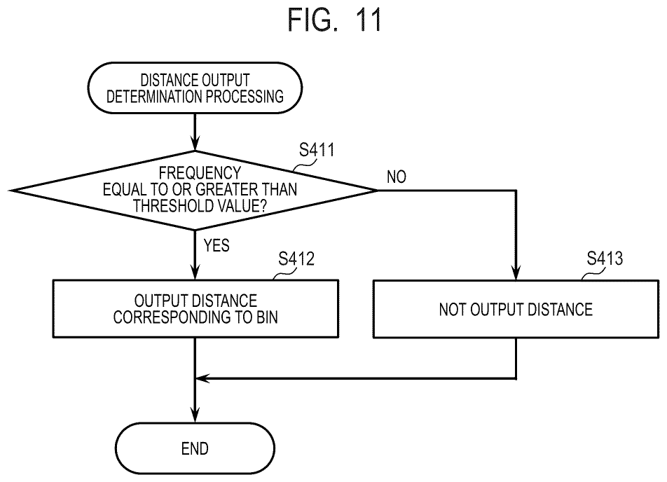

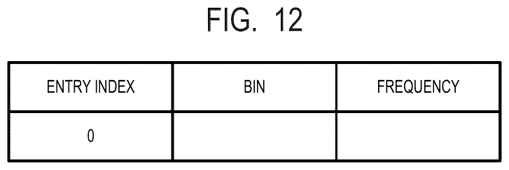

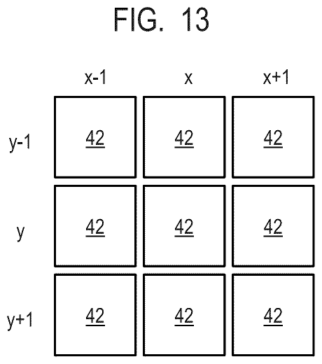

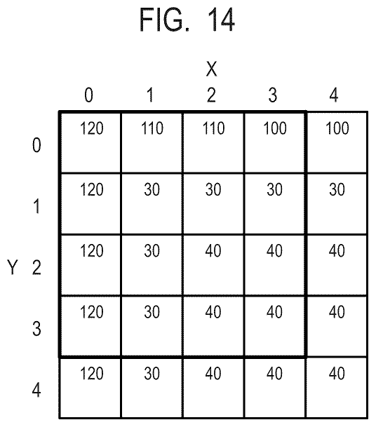

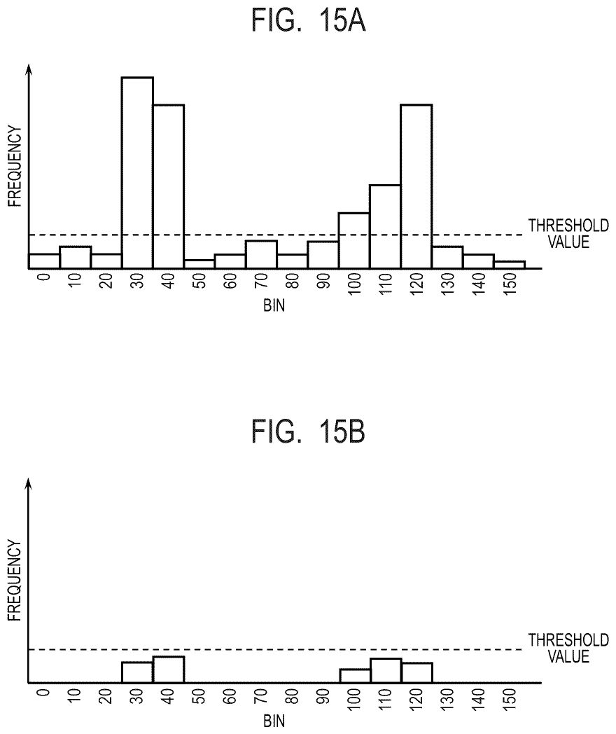

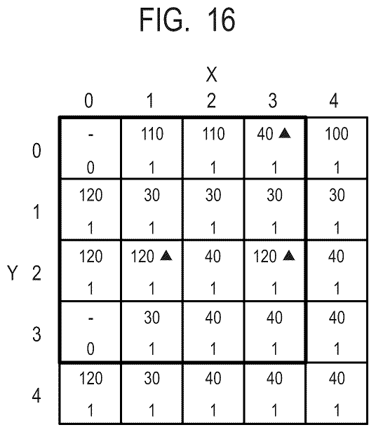

A ranging device and a ranging method according to a second embodiment will be described with reference to FIG. 9 to FIG. 18. The same components as those of the ranging device according to the first embodiment are denoted by the same reference numerals, and description thereof will be omitted or simplified. FIG. 9 to FIG. 11 are flowcharts illustrating the operation of the ranging device according to the present embodiment. FIG. 12 is a diagram illustrating a configuration example of an entry held by a data accumulation unit of a distance calculation unit in the ranging device according to the present embodiment. FIG. 13 is a diagram illustrating a positional relationship between a focused pixel and peripheral pixels. FIG. 14, FIG. 16, FIG. 17, and FIG. 18 are diagrams illustrating an operation example of the ranging device according to the present embodiment. FIG. 15A and FIG. 15B are diagrams illustrating an example of the low-resolution histogram acquired in the first period and an example of the low-resolution histogram of the ambient light acquired in the second period.

The ranging device according to the present embodiment is the same as the ranging device according to the first embodiment except that the processing in the distance calculation unit 50 is different. In the present embodiment, differences from the ranging device according to the first embodiment will be mainly described, and description of points similar to those of the ranging device according to the first embodiment will be appropriately omitted.

In general, there is a spatial correlation between data of a certain pixel and data of pixels around the certain pixel. In the present embodiment, this property is utilized to reduce the memory capacity of the data accumulation unit 52. In the present embodiment, when updating data of a certain pixel, the data accumulation unit 52 refers to data of pixels around the pixel. In addition, when the reflected light determination unit 54 performs the reflected light determination on a certain pixel, data of pixels around the pixel is also referred to.

In the present embodiment, in order to simplify the description, it is assumed that the data accumulation unit 52 includes one entry for each pixel as illustrated in FIG. 12. The one entry includes a data region for holding bin and frequency corresponding to the bin. Since there is one entry for each pixel, a number of 0 is assigned to the entry as an entry index. In addition, in the data accumulation unit 52 of the distance calculation unit 50, the frequency of the focused pixel is weighted by adding the frequency of the entry in the range of −1 to +1 of the light reception time bin of the surrounding eight pixels, and the update probability is calculated based on the total frequency. Note that the number of entries, the number of peripheral pixels, the range of the light reception time bin at which the frequency is summed, and the update probability are arbitrary, and may be appropriately changed in accordance with the use state. In addition, in the present embodiment, the range of the bin is set to 0 to 999, and the bin 999 indicates that there is no object that reflects light.

In the present embodiment, in the initialization processing of step S101, for example, as described in step S211 of FIG. 9, the value of the bin of the entry of each pixel is initialized to 999 and the value of the frequency is initialized to 0 (no registration).

The state update processing of step S110 may be performed according to steps S311 to S316 of the flowchart illustrated in FIG. 10, for example. Step S110 is executed for each signal of the coordinates (X, Y) in the data accumulation unit 52 of the distance calculation unit 50.

First, in step S311, it is determined whether or not the same bin as the bin calculated in step S109 exists in each entry of the data accumulation unit 52 illustrated in FIG. 12. As a result of the determination, when there is the same bin as the bin calculated in step S109 (“YES” in step S311), the process proceeds to step S316. When there is no bin identical to the bin calculated in step S109 (“NO” in step S311), the process proceeds to step S312.

In step S312, the frequency of the pixel of interest and the frequencies of the peripheral pixels to which the weighting according to the value of the bin is added are summed. For example, a value of (frequency×¼) is added to the frequency of a pixel of interest for a peripheral pixel having the same bin value as that of the pixel of interest. For a peripheral pixel whose bin value is ±1 of the bin value of the pixel of interest, a value of (frequency× 1/16) is added to the frequency of the pixel of interest.

For example, as illustrated in FIG. 13, it is assumed that a total of nine light receiving elements 42 are two-dimensionally arranged at coordinates (x−1, y−1) to coordinates (x+1, y+1), and a pixel of interest is the light receiving element 42 at coordinates (x, y). In this case, the peripheral pixels may be eight pixels (light receiving elements 42) other than the pixel of interest at the coordinate (x, y) among the nine pixels. The fact that the value obtained by adding the frequencies of these pixels is large indicates that the distance between the object in the detection range of the pixel of interest and the object in the detection range of the peripheral pixel is short, and it is considered that the bin is highly likely to represent the correct distance of the object.

In step S313, the update probability with respect to the frequency is calculated. As described above, since the higher the value obtained by adding the frequencies of the pixels, the higher the possibility of representing the correct distance of the object, when obtaining the update probability with respect to the frequency, it is preferable to reduce the update probability when the added value is large, and to increase the update probability when the added value is small. For example, when the added value is 1 or less, the update probability is set to ½, and when the added value exceeds 1 and is 4 or less, the update probability is set to ¼. When the added value exceeds 4 and is 16 or less, the update probability is set to 1/16, and when the added value exceeds 16 and is 32 or less, the update probability is set to 1/32. In the present embodiment, since the number of entries corresponding to each pixel is reduced, the bins are stochastically updated.

Next, in step S314, it is determined whether or not the update probability calculated in step S313 is equal to or less than a random number value (here, a range from 0 to 1). As a result of the determination, when the random number value is equal to or larger than the update probability (“YES” in step S314), the state update processing is ended without updating the entry. If the random number value is less than the update probability (“NO” in step S314), the process proceeds to step S315.

In step S315, the bin is set to the light reception time bin, the frequency is set to 1, and the state update processing is ended.

In step S316, the frequency of entry having the same bin as the light reception time bin calculated in step S109 is increased by 1, and the state update processing is ended.

The distance output determination process in step S113 may be performed in accordance with steps S411 to S413 of the flowchart illustrated in FIG. 11, for example. Step S113 is performed on each signal of the coordinates (Xi, Yi) in the reflected light determination unit 54 of the distance calculation unit 50.

First, in step S411, it is determined whether or not the value of the frequency in the entry of the data accumulation unit 52 illustrated in FIG. 12 is equal to or higher than a predetermined threshold value. As a result of the determination, when the value of the frequency is equal to or higher than the threshold value (“YES” in step S411), the process proceeds to step S412. When the value of the frequency is less than the threshold (“NO” in step S411), the process proceeds to step S413. When the frequency is determined, the frequency of the peripheral pixels to which a predetermined weighting is applied may be added to the frequency of the pixel of interest by the same method as in step S312.

In step S412, it is determined that the entry corresponds to the reflected light, and the bin of the entry is converted into a distance and output. As a result, the distance output determination processing is ended, and a series of processing of the frame is ended.

In step S413, it is determined that the entry does not correspond to reflected light, and it is output that there is no object whose distance can be measured. As a result, the distance output determination processing is ended, and a series of processing of the frame is ended.

As described above, when it is determined that the reflected light is at the coordinates (XL, YL) of the low-resolution pixel by the state update processing illustrated in FIG. 10, the frequency of the bin with respect to the coordinates (X, Y) at which the light is received becomes large. When the frequency is equal to or higher than a predetermined threshold value, it is determined that the bin indicates the reflected light, and the bin is converted into a distance and output.

Next, a specific example of the operation in step S110 will be described with reference to FIG. 14 to FIG. 18. Here, in order to simplify the description, it is assumed that the bin in the low-resolution histogram and the light reception time bin in the distance calculation unit 50 are the same.

In FIG. 14, the distances to the object detected by the pixels (light receiving elements 42) from the coordinates (0, 0) to the coordinates (4, 4) are represented by the value of the light reception time bin in the distance calculation unit 50. Of these pixels, 16 pixels from coordinates (0, 0) to coordinates (3, 3) (pixels surrounded by thick lines in FIG. 14) are included in one low-resolution pixel (coordinates (XL, YL)=(0, 0)).

FIG. 15A is a low-resolution histogram of a low-resolution pixel (coordinates (XL, YL)=(0, 0)), and illustrates an example of a frequency distribution of light (the sum of reflected light and ambient light) received by the pixel until the pixel enters a state in which determination of reflected light is possible in one frame. In this example, the frequency is higher than or equal to the threshold value in the bin corresponding to the time count values 30, 40, 100, 110 and 120. Therefore, in the low-resolution histogram, it is determined that the bins corresponding to the time count values 30, 40, 100, and 120 indicate the reflected light, and the distance calculation unit 50 corresponding to the coordinates (X, Y) of the light received pixel operates.

FIG. 15B is a low-resolution histogram of the low-resolution pixel (coordinates (XL, YL)=(0, 0)), and illustrates an example of a frequency distribution of ambient light output after being a state in which it is possible to determine reflected light in one frame and being determined that reflected light is present. In this example, environmental light is detected as reflected light in bins corresponding to the time count values 30, 40, 100, 110 and 120.

FIG. 16 illustrates bins and frequencies at a certain point in time in the pixels (light receiving elements 42) from coordinates (0, 0) to coordinates (4, 4). Of the two numerical values described in each coordinate, the upper row indicates the value of the bin, and the lower row indicates the value of the frequency. When the bin is ambient light and is different from the bin in FIG. 14, the right side of the value of the bin is marked with a triangle.

At this time point, it is assumed that light is detected in the pixel at the coordinates (1, 2), and the light reception time bin in the distance calculation unit 50 is 30. When it is determined in step S311 whether or not there is an entry of the same bin as the light reception time bin, since the bin of the entry of the pixel at the coordinates (1, 2) is 120, the process proceeds to step S312. In step S312, weighted addition of the frequencies of neighboring pixels whose bin values are close to that of the pixel of interest is performed on the values of the frequency of the pixel of interest at the coordinates (1, 2). In this example, since there are two pixels having the same bin value and a frequency of 1 among the surrounding pixels and there are no pixels having a bin value of −1 or 1, for example, calculation of (1+(1+1)×¼+0×⅛) is performed according to the above-described rule, and the value of the frequency is 1.5. In step S313, the update probability with respect to the frequency is calculated as ¼. In step S314, ¼ of the update probability is compared with a random number value greater than or equal to 0 and less than 1. Since the random number value is 0.81 and is larger than the state update probability, the state update is ended without changing the bin and the frequency.

FIG. 17 illustrates bins and frequencies at a certain point in time in the pixels (light receiving elements 42) from the coordinates (0, 0) to the coordinates (4, 4).

At this time point, it is assumed that light is detected in the pixel at the coordinates (1, 2), and the light reception time bin in the distance calculation unit 50 is 30. When it is determined in step S311 whether or not there is an entry of the same bin as the light reception time bin, since the bin of the entry of the pixel at the coordinates (1, 2) is 120, the process proceeds to step S312. In step S312, weighted addition of the frequencies of neighboring pixels whose bin values are close to that of the pixel of interest is performed on the value of the frequency of the pixel of interest at the coordinates (1, 2). In this example, since there are one pixel having the same bin value and a frequency of 1 and two pixels having a frequency of 2 among the surrounding pixels and there are no pixels having a bin value of −1 or +1, for example, calculation of (1+(2+2+1)×¼+0×⅛) is performed according to the above-described rule, and the value of the frequency is 2.25. In step S313, the update probability with respect to the frequency is calculated as ¼. In step S314, ¼ of the update probability is compared with a random number value greater than or equal to 0 and less than 1. Since the random number value is 0.12 and is smaller than the state update probability, the process proceeds to step S315, the bin is set to 30 which is the light reception time bin, and the frequency is set to 1, and the state update is ended.

FIG. 18 illustrates bins and frequencies after state update in the pixels (light receiving elements 42) from coordinates (0, 0) to coordinates (4, 4). It can be seen that the value of the bin of the coordinate (1, 2) is the same as the value of FIG. 14.

By performing such processing, necessary memory capacity may be reduced. The reason for this will be described below by exemplifying a case in which the number of bins is 1000 (for example, the distance can be measured up to 100 m with a distance resolution of 10 cm) and the number of shot periods SP per frame period FP is 10,000 times. It is assumed that the number of pixels of the light receiving unit 40 (the number of light receiving elements 42) is 256 pixels (16 pixels in horizontal direction×16 pixels in vertical direction) as in the above example.

In the present embodiment, the memory capacity required to hold the low-resolution histogram information is 224,000 bits, as in the first embodiment. The memory capacity required for each pixel is (ceil(log₂(number of bins))+ceil(log₂(number of shots))) bits, and (((16×16×(10+14))=6,144) bits for all pixels. The total is 230,144 bits, which can be significantly smaller than the normal 3,584,000 bits.

As described above, according to the present embodiment, it is possible to reduce the required memory capacity while maintaining the ranging accuracy and resolution.

### Third Embodiment

A ranging device and a ranging method according to a third embodiment will be described. The same components as those of the ranging device according to the first or second embodiment are denoted by the same reference numerals, and description thereof will be omitted or simplified.

The ranging device according to the present embodiment is the same as the ranging device according to the first embodiment except that the processing in the reflected light determination unit 74 of the low-resolution histogram processing unit 70 is different. In the present embodiment, differences from the ranging device according to the first embodiment will be mainly described, and description of points similar to those of the ranging device according to the first embodiment will be appropriately omitted.

In the first and second embodiments, the reflected light determination unit 74 determines the reflected light based on the low-resolution histogram information generated in the data accumulation unit 72 of the low-resolution histogram processing unit 70. However, depending on the measurement environment, the difference between the ambient light and the reflected light may not necessarily be sufficiently ensured, and the reflected light may not be determined. In the present embodiment, an example of a coping method in such a case will be described.

As described above, although the resolution is lowered by performing the pixel binning processing, the light reception probability of the reflected light is increased. From such a viewpoint, in the present embodiment, when it is difficult to determine the reflected light in the histogram information based on the data generated by the binning processing unit 60, the reflected light determination unit 74 generates histogram information having a lower resolution. Then, by using the histogram information having the lower resolution, the determination of the reflected light is performed by using, for example, the same method as in the first embodiment. In this way, it is possible to discriminate between the reflected light and the environmental light more easily. For example, histogram information having a lower resolution may be generated based on a plurality of signals corresponding to a plurality of pixel block groups each including at least two pixel blocks used to generate a low-resolution histogram.

As described above, according to the present embodiment, it is possible to reduce the required memory capacity while maintaining the ranging accuracy and resolution.

### Fourth Embodiment

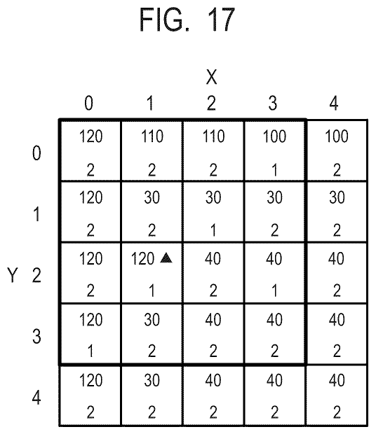

A ranging device and a ranging method according to a fourth embodiment will be described with reference to FIG. 19. The same components as those of the ranging device according to the first or second embodiment are denoted by the same reference numerals, and description thereof will be omitted or simplified. FIG. 19 is a diagram illustrating a configuration example of a data area of a data accumulation unit in the ranging device according to the present embodiment.

The ranging device according to the present embodiment is the same as the ranging device according to the first embodiment except that the data accumulation unit 72 of the low-resolution histogram processing unit 70 and the data accumulation unit 52 of the distance calculation unit 50 share a storage device. In the present embodiment, differences from the ranging device according to the first embodiment will be mainly described, and description of points similar to those of the ranging device according to the first embodiment will be appropriately omitted.

In the present embodiment, the data accumulation unit 52 of the distance calculation unit 50 uses the storage unit of the data accumulation unit 72 of the low-resolution histogram processing unit 70, but other functional blocks may include a storage device.

In the present embodiment, for convenience of explanation, the number of shot periods SP per frame period FP is 10,000 (maximum value of frequency=10,000), and the number of bins per shot period SP is 1,000. Further, it is assumed that the number of pixels binned by the binning processing unit 60 is 16 (4 pixels in horizontal direction×4 pixels in vertical direction), and the number of entries in the data accumulation unit 52 is 4. However, these may be arbitrarily changed.

As illustrated in FIG. 19, the data held in the process of the ranging device performing the ranging process includes frequency data 92 of the low-resolution histogram, data 94 of entries of a coordinate range to be binned, and data 96 of bins of the low-resolution histogram for determining reflected light. In the first embodiment, the frequency data 92 of the low-resolution histogram is stored in the data accumulation unit 72 of the low-resolution histogram processing unit 70. In addition, data 94 of entries of the coordinate range to be binned and data 96 of bins of the low-resolution histogram for determining reflected light are held in the data accumulation unit 52 of the distance calculation unit 50.

On the other hand, in the present embodiment, these pieces of data are held in the data accumulation unit 72 of the low-resolution histogram processing unit 70. The data area holding the frequency data 92 of the low-resolution histogram and the data area holding the data 94 of the entries of the coordinate range to be binned are shared to reduce the memory capacity. In other words, the data area holding the frequency data 92 of the low-resolution histogram and the data area holding the data 94 of the entries of the coordinate range to be binned at least partially overlap. In such a configuration, since only one of the frequency data 92 of the low-resolution histogram and the data 94 of the entries of the coordinate range to be binned may be held in the data accumulation unit 72, the following processing is performed in the present embodiment.

When the reflected light determination unit 74 of the low-resolution histogram processing unit 70 is not in a state in which reflected light determination is possible, the low-resolution histogram processing unit 70 updates the low-resolution histogram using the frequency data 92 of the low-resolution histogram held in the data accumulation unit 72. When the low-resolution histogram processing unit 70 updates the frequency data of the low-resolution histogram, the light reception count value is accumulated as the frequency in step S107 for the bin of the low-resolution histogram calculated in step S106. Since the frequency data of the low-resolution histogram has 1,000 bins, 1,000 frequencies may be stored from the frequency of bin 0 to the frequency of bin 999. At this time, the distance calculation unit 50 is in a stopped state, and the distance calculation unit 50 does not use the data 94 of the entries of the coordinate range to be binned. That is, the data accumulation unit 72 of the low-resolution histogram processing unit 70 may be used to hold the frequency data 92 of the low-resolution histogram.

When transitioning from a state in which reflected light determination is not possible to a state in which reflected light determination is possible, the reflected light determination unit 74 converts the data held by the data accumulation unit 72 from the frequency data 92 of the low-resolution histogram to the data 96 of the bins of the low-resolution histogram for reflected light determination. The generated data 96 of the low-resolution histogram for determining reflected light is stored in the data accumulation unit 72. In this conversion process, the value of the bins having frequency equal to or greater than the threshold value and having frequency of from highest to k-th highest are extracted from the frequency data 92 of the low-resolution histogram as the bins of the low-resolution histogram for determining the reflected light. In the example of FIG. 19, the value of k is 16 (the number of pixels to be binned). The reflected light determination unit 74 may perform the reflected light determination even if the frequency data 92 of the low-resolution histogram is not complete as long as the data 96 of the bins of the low-resolution histogram for the reflected light determination is present.

When the reflected light determination is possible, the data 94 of the entries of the coordinate range to be binned and the data 96 of the bins of the low-resolution histogram for the reflected light determination are valid. The reflected light determination unit 74 performs the reflected light determination using the data 96 of the bins of the low-resolution histogram for the reflected light determination. The distance calculation unit 50 calculates the light reception time bin using the data 94 of the entries of the coordinate range to be binned in step S109, and performs the state update processing in step S110.

When the number of pixels to be binned is 16 (4 pixels in the horizontal direction×4 pixels in the vertical direction), the data held by the data accumulation unit 72 as the data 94 of the entries of the coordinate range to be binned includes data of 16 pixels from coordinates (0, 0) to coordinates (3, 3). The data of each pixel includes four entries. One entry is composed of a bin and a frequency. That is, as the data of the entries of the coordinate range to be binned, the data accumulation unit 52 includes 128 data.

In the above example, one data of the entry of the coordinate range to be binned corresponds to one data of the frequency data of the low-resolution histogram. In addition, the number of pieces of data of the entries of the coordinate range to be binned is smaller than the number of pieces of data of the frequency data of the low-resolution histogram. Therefore, in this example, the data area corresponding to the frequency of the bin 128 to the frequency of the bin 999 of the frequency data of the low-resolution histogram is not used as the data area of the entries of the coordinate range to be binned.

As described above, according to the present embodiment, it is possible to reduce the required memory capacity while maintaining the ranging accuracy and resolution.

### Fifth Embodiment

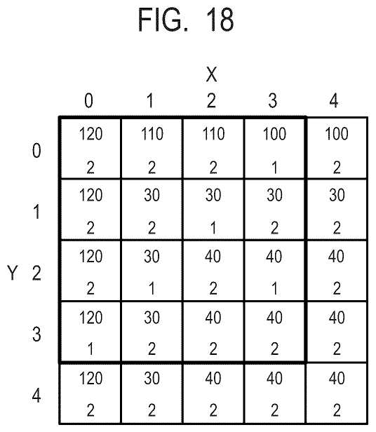

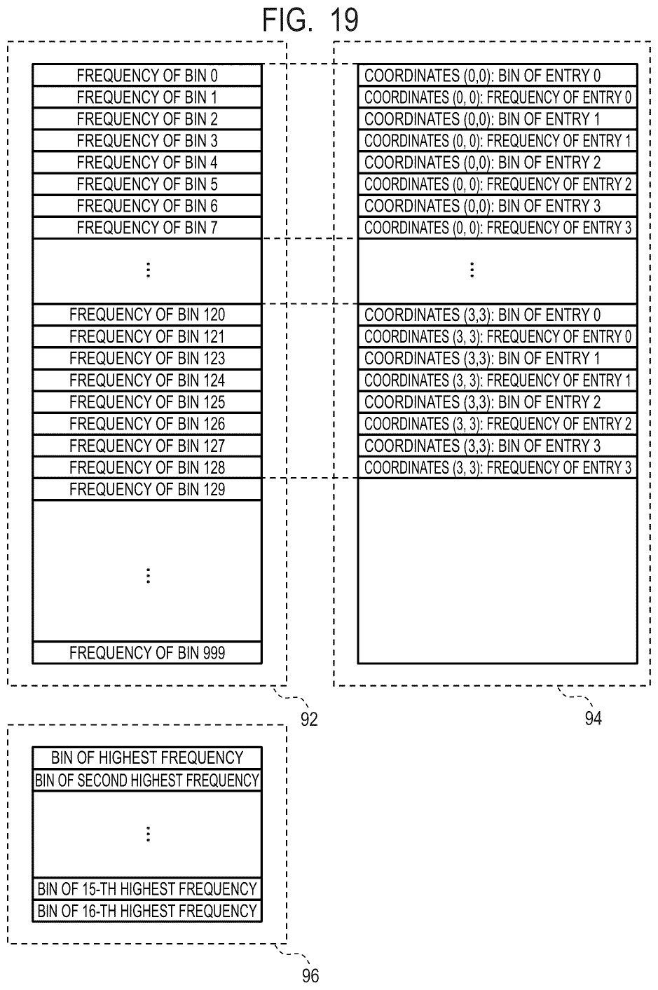

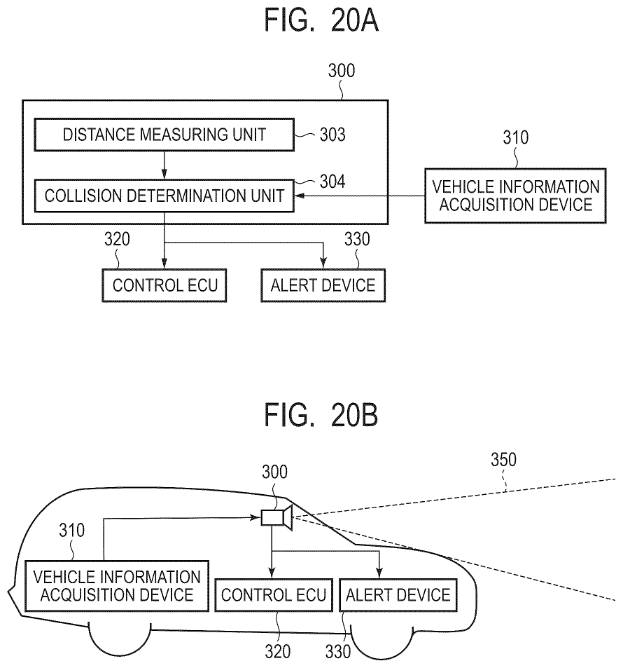

A movable object according to a fifth embodiment will be described with reference to FIG. 20A and FIG. 20B. FIG. 20A and FIG. 20B are diagrams illustrating a configuration example of a movable object according to the present embodiment.

FIG. 20A illustrates a configuration example of equipment mounted on a vehicle as an on-vehicle camera. The equipment 300 includes a distance measurement unit 303 that measures a distance to an object, and a collision determination unit 304 that determines whether or not there is a possibility of collision based on a distance measured by the distance measurement unit 303. The distance measurement unit 303 is configured by the ranging device 100 described in any of the first to fourth embodiments. Here, the distance measurement unit 303 is an example of a distance information acquisition unit that acquires distance information to the object. That is, the distance information is information related to a distance to the object or the like.

The equipment 300 is connected to the vehicle information acquisition device 310, and may acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the determination result of the collision determination unit 304 indicates that the possibility of collision is high, the control ECU 320 performs vehicle control to avoid collision and reduce damage by, for example, applying a brake, returning an accelerator, or suppressing engine output. The alert device 330 gives a warning to the user by sounding a warning such as a sound, displaying warning information on a screen of a car navigation system or the like, giving vibration to a seat belt or a steering wheel, or the like. These devices of the equipment 300 function as a movable object control unit that controls the operation of controlling the vehicle as described above.

In the present embodiment, the distance to the surroundings of the vehicle, for example, the front or the rear is measured by the equipment 300. FIG. 20B illustrates equipment in the case of distance measurement in front of the vehicle (distance measurement range 350). The vehicle information acquisition device 310 serving as the ranging control unit sends an instruction to the equipment 300 or the distance measurement unit 303 to perform the ranging operation. With such a configuration, the accuracy of distance measurement may be further improved.

In the above description, an example in which control is performed so as not to collide with another vehicle has been described, but the present disclosure is also applicable to control in which automatic driving is performed so as to follow another vehicle, control in which automatic driving is performed so as not to protrude from a lane, and the like. Furthermore, the equipment is not limited to vehicles such as automobiles, and may be applied to a movable object (moving device), such as ships, aircrafts, artificial satellites, industrial robots, consumer robots, and the like. In addition, the present invention is not limited to movable object, and may be widely applied to devices utilizing object recognition or biological recognition, such as an ITS (Intelligent Transport Systems), a monitoring system, and the like.

### Modified Embodiments

The present disclosure is not limited to the above-described embodiments, and various modifications are possible.

For example, examples in which some of the configurations of any of the embodiments are added to other embodiments or examples in which some of the configurations of any of the embodiments are substituted with some of the configurations of the other embodiments are also an embodiment of the present disclosure.

In the above-described embodiments, the light emitting unit 10 and the light receiving unit 40 are described as a part of the components of the ranging device 100, but at least one of the light emitting unit 10 and the light receiving unit 40 does not necessarily need to be a part of the configuration of the ranging device 100.

Although the ranging device has been described in the above-described embodiments, the algorithm described in the above embodiment may also be applied to an information processing device for processing a signal output from the light receiving unit 40. In this case, an information processing device may be configured by an input unit to which a signal is input, the distance calculation unit 50, the binning processing unit 60, the low-resolution histogram processing unit 70, and the output unit 80. The information processing device may be a device such as a personal computer including a processor (for example, a CPU or an MPU). Alternatively, the information processing device may be a circuit such as an ASIC that realizes functions of an input unit to which a signal is input, the distance calculation unit 50, the binning processing unit 60, the low-resolution histogram processing unit 70, and the output unit 80.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for implementing the present disclosure, and the technical scope of the present disclosure should not be interpreted in a limited manner by these embodiments. That is, the present disclosure can be implemented in various forms without departing from the technical idea or the main feature thereof.

According to the present disclosure, in the ranging device and the ranging method, it is possible to reduce a necessary memory capacity while maintaining ranging accuracy and resolution.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-094206, filed Jun. 7, 2023, which is hereby incorporated by reference herein in its entirety.

What is claimed is:

1. A ranging device comprising:
a light receiving unit including a plurality of pixels configured to detect a pulsed light emitted from a light emitting unit and reflected by an object in a measurement target region;
a binning processing unit configured to convert a plurality of signals output from a plurality of unit regions each including at least one pixel into a plurality of signals corresponding to a plurality of pixel blocks each including at least two unit regions;
a data accumulation unit configured to accumulate, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit;
a reflected light determination unit configured to extract, for each of the plurality of unit regions, a candidate of a class including a signal based on a reflected light from the object from the information; and
a distance calculation unit configured to calculate a distance to the object corresponding to each of the plurality of unit regions based on the candidate.

2. The ranging device according to claim 1,
wherein the data accumulation unit is configured to generate the information by counting, for each class, pulse signals output from the binning processing unit at a plurality of times in response to a plurality of times of light emission of the pulsed light in a first period in one frame period, and
wherein the reflected light determination unit is configured to extract the candidate based on pulse signals output at a plurality of times from the plurality of unit regions in response to a plurality of times of light emission of the pulsed light in a second period after the first period in the one frame period.

3. The ranging device according to claim 1,
wherein the reflection light determination unit includes
a first determination unit configured to determinate, in a case where at least one unit region of the plurality of unit regions detects light, whether or not there is a possibility that an output signal of a pixel block including the one unit region includes a signal according to a reflected light from the object; and
a second determination unit configured to determine whether or not there is a possibility that an output signal of the one unit region includes a signal according to a reflected light from the object, and
wherein the reflection light detection unit is configured to extract, when both the first determination unit and the second determination unit determine that there is a possibility that the signal according to reflected light from the object is included, a class corresponding to a timing at which the one unit region detects light as the candidate corresponding to the one unit region.

4. The ranging device according to claim 2,
wherein the reflection light determination unit includes
a first determination unit configured to determinate, in a case where at least one unit region of the plurality of unit regions detects light, whether or not there is a possibility that an output signal of a pixel block including the one unit region includes a signal according to a reflected light from the object; and
a second determination unit configured to determine whether or not there is a possibility that an output signal of the one unit region includes a signal according to a reflected light from the object, and
wherein the reflection light detection unit is configured to extract, when both the first determination unit and the second determination unit determine that there is a possibility that the signal according to reflected light from the object is included, a class corresponding to a timing at which the one unit region detects light as the candidate corresponding to the one unit region.

5. The ranging device according to claim 3, wherein
the first determination unit and the second determination unit determine that there is a possibility that the output signal includes the signal according to the reflected light from the object when a class corresponding to a timing at which the one unit region detects light corresponds to a class having a frequency equal to or higher than a predetermined threshold value among classes constituting the information.

6. The ranging device according to claim 3,
wherein the distance calculation unit is configured to count for the candidate the number of times that the second determination unit determines that there is a possibility of including the signal according to the reflected light from the object, and
wherein the distance calculation unit is configured to output, when the count value of the class having the largest number of times among the candidates exceeds a prescribed threshold value, a distance corresponding to a class having the largest number of times as a distance to the object in the one unit region.

7. The ranging device according to claim 5, wherein the distance calculation unit is configured to add, when a class corresponding to a timing at which the one unit region detects light is not included in the candidate, the class corresponding to the timing at which the one unit region detects light to the candidate.

8. The ranging device according to claim 5, wherein the distance calculation unit is configured to select, when a class corresponding to a timing at which the one unit region detects light is not included in the candidate, the class corresponding to the timing at which the one unit region detects light as the candidate with an update probability according to the count value of the one unit region and unit regions around the one unit region.

9. The ranging device according to claim 1, wherein the data accumulation unit is configured to accumulate the information based on a plurality of signals corresponding to a plurality of pixel block groups each including at least two pixel blocks for each of the plurality of pixel block groups.

10. The ranging device according to claim 2, wherein the data accumulation unit is configured to accumulate the information based on a plurality of signals corresponding to a plurality of pixel block groups each including at least two pixel blocks for each of the plurality of pixel block groups.

11. The ranging device according to claim 1,
wherein the data accumulation unit includes a first data area for holding the information corresponding to each of the plurality of unit regions and a second data area for holding the candidate and the frequency thereof for each of the plurality of unit regions constituting the pixel block, and
wherein at least a part of the first data area and the second data area overlap each other.

12. The ranging device according to claim 2,
wherein the data accumulation unit includes a first data area for holding the information corresponding to each of the plurality of unit regions and a second data area for holding the candidate and the frequency thereof for each of the plurality of unit regions constituting the pixel block, and
wherein at least a part of the first data area and the second data area overlap each other.

13. The ranging device according to claim 1, wherein each of the plurality of unit regions includes one pixel.

14. The ranging device according to claim 2, wherein each of the plurality of unit regions includes one pixel.

15. The ranging device according to claim 1, further comprising: a conversion unit configured to convert a spatial resolution of a signal output from the light receiving unit,
wherein the conversion unit converts the plurality of signals output from the plurality of pixels into the plurality of signals corresponding to the plurality of unit regions.

16. The ranging device according to claim 15,
wherein each of the plurality of unit regions includes two or more first number of the pixels, and
wherein each of the plurality of pixel blocks includes a second number of the pixels greater than the first number.

17. A ranging device comprising:
a light receiving unit including a plurality of pixels configured to detect a pulsed light emitted from a light emitting unit and reflected by an object in a measurement target region;
a binning processing unit configured to convert a plurality of first signals output from the plurality of pixels into a plurality of second signals having spatial resolution lower than that of the plurality of first signals;
a data accumulation unit configured to accumulate, for each of a plurality of first unit regions corresponding to the plurality of second signals, information indicating a relationship between a class determined according to a time from when the pulsed light is emitted to when the pulsed light is detected by the light receiving unit and a frequency indicating the number of times the pulsed light is detected, based on the plurality of second signals output from the binning processing unit;
a reflected light determination unit configured to extract, for each of a plurality of second unit regions corresponding to a plurality of signals having a spatial resolution higher than that of the plurality of second signals, a candidate of a class including a signal based on a reflected light from the object from the information; and
a distance calculation unit configured to calculate a distance to the object corresponding to each of the plurality of second unit regions based on the candidate.

18. The ranging device according to claim 17,
wherein the plurality of signals having the special resolution higher than that of the plurality of second signals is the plurality of first signals, and
wherein the plurality of second unit regions is the plurality of pixels.

19. The ranging device according to claim 17, wherein the plurality of signals having the special resolution higher than that of the plurality of second signals is a plurality of third signals having a special resolution higher than that of the plurality of second signals and different from the plurality of first signals.

20. An information processing device comprising:
an input unit to which signals output from a plurality of pixels that detect pulsed light emitted from a light emitting unit and reflected by an object in a measurement target region are input;
a binning processing unit configured to convert a plurality of signals output from a plurality of unit regions each including at least one pixel into a plurality of signals corresponding to a plurality of pixel blocks each including at least two unit regions;
a data accumulation unit configured to accumulate, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit;
a reflected light determination unit configured to extract, for each of the plurality of unit regions, a candidate of a class including a signal based on a reflected light from the object from the information; and
a distance calculation unit configured to calculate a distance to the object corresponding to each of the plurality of unit regions based on the candidate.

21. A movable object comprising:
the ranging device according to claim 1, and
a control device configured to control the movable object based on distance information acquired by the ranging device.

22. A movable object comprising:
the ranging device according to claim 2, and
a control device configured to control the movable object based on distance information acquired by the ranging device.

23. A ranging method in which a pulsed light emitted from a light emitting unit and reflected by an object in a measurement target region is detected by a plurality of pixels and a distance to the object is calculated based on signals detected by the plurality of pixels, the method comprising:
converting a plurality of signals output from a plurality of unit regions each including at least one pixel into a plurality of signals corresponding to a plurality of pixel blocks each including at least two unit regions;
accumulating, for each of the plurality of pixel blocks, information indicating a relationship between a class determined according to a time from when the pulsed light is emitted to when the pulsed light is detected by the light receiving unit and a frequency indicating the number of times the pulsed light is detected, based on the plurality of signals output from the binning processing unit;
extracting, for each of the plurality of unit regions, a candidate of a class including a signal based on a reflected light from the object from the information; and
calculating a distance to the object corresponding to each of the plurality of unit regions based on the candidate.
